(19) United States
(12) Patent Application Publication
(10) Pub. No.: US 2023/0250882 A1
(43) Pub. Date: Aug. 10, 2023

(54) SYSTEM AND METHOD OF WINTERIZING AND DE-WINTERIZING A STRUCTURE FOR PREVENTING WATERLINES FROM FREEZING

(71) Applicant: Jeremia Taylor, Vallecito, CA (US)

(72) Inventor: Jeremia Taylor, Vallecito, CA (US)

(21) Appl. No.: 18/135,379

(22) Filed: Apr. 17, 2023

Related U.S. Application Data
(63) Continuation-in-part of application No. 17/700,218, filed on Mar. 21, 2022.
(60) Provisional application No. 63/163,517, filed on Mar. 19, 2021.

(51) Int. Cl. F16K 5/06; F16K 31/04; F16K 11/087; F16K 37/00; E03B 7/12

(52) U.S. Cl. CPC F16K 5/0652; F16K 31/042; F16K 11/0873; F16K 37/005; E03B 7/12; F16K 24/04

(57) ABSTRACT

The present subject matter discloses a system and method of winterizing and de-winterizing a structure in order to prevent waterlines from freezing and getting damaged. The system includes electronic valves connected to waterlines i.e., main waterline and drain line. The electronic valves include electronic ball valves. The electronic valves communicatively connect to an electronic device. A user operates the electronic device to winterize and de-winterize the structure. Winterizing includes closing the electronic valve on the main waterline that supplies water into the structure and opening the electronic valve on the drain line causing the water to drain out. De-wintering includes closing the electronic valve on the drain line and opening the electronic valve on the main waterline to supply water back into the structure. Winterizing prevents the waterlines from freezing and getting damaged in cold weather conditions.

### RELATED APPLICATIONS AND CLAIM FOR PRIORITY

The present application is a continuation-in-part (CIP) application of U.S. patent application Ser. No. 17/700,218 filed Mar. 21, 2022; which claims the benefit of U.S. Provisional Application No. 63/163,517, filed Mar. 19, 2021; all of which are incorporated herein by their entirety and referenced thereto.

### FIELD OF THE INVENTION

The present subject matter generally relates to electronic valves installed on waterlines for preventing the waterlines from freezing. More specifically, the present subject matter relates to a system and method of winterizing and de-winterizing a structure such as a home of office, the system comprises electronic valves installed on waterlines that supply or drain water from the structure, the electronic ball valves are controlled remotely using an electronic device such as a mobile phone, the electronic valves are controlled to open and close the main waterline and drain line causing the water to drain out and supply back into the structure to protect the waterlines from freezing and getting damaged.

### BACKGROUND OF THE INVENTION

It is known that extreme cold temperature causes water in waterlines or water supply systems or pipes to freeze. Freezing of water in pipes can occur when ambient temperatures drop to 32° Fahrenheit (F) or 0° Celsius (C) and below. Freezing of water in the pipes leads to rupturing of the pipes and subsequent damage to a structure such as a home by the melted water. Typically, users or occupants at the home manually open an exposed valve of the pipes to allow steady dripping of the water at the onset of potentially freezing weather to prevent such damage. However, it is not easy for the occupants to be aware and operate the valve in such freezing conditions. Moreover, if the occupants are away from home when the freezing occurs, or if the home is a vacation home in an area where freezing is normally unexpected, such manual opening of the valve may not be possible.

In order to overcome the above problems, several solutions have been proposed in the past. One such solution includes providing a temperature-actuated valve. An example of temperature-actuated valve is disclosed in a U.S. Pat. No. 5,715,855 entitled “Temperature-activated valve” (the “855 Patent”). The '855 Patent discloses a temperature-actuated valve that includes an elongated housing having anterior and posterior segments, the anterior segment being connected to an outdoor water supply. A valve within the anterior segment opens in response to freezing temperatures, defining a fluid path that allows water from the outdoor water supply to flow through one or more discharge ports; and which closes when the temperature rises above freezing. The valve generally includes a piston movable within the housing and having a valve head, and a valve seat formed in the anterior housing segment; seating of the valve head against the valve seat closes the discharge port(s). The device also includes means for conducting water from the anterior housing segment to the posterior housing segment, the latter comprising an expansion reservoir for freezing water. When water freezes, its expansion moves the piston so as to unseat the valve head and thereby allow water to be discharged through the discharge port(s). Thawing of the water in the expansion reservoir allows the valve head, under pressure from the outdoor water supply, to reseat.

Another example is disclosed in a U.S. Pat. No. 6,530,391 entitled “Temperature-activated valve” (the “391 Patent”). The '391 Patent discloses a temperature and pressure sensitive valve having a valve piston for regulating flow through the valve, a valve piston guide for directing movement of the piston, the piston guide having one or more passages there through, a thermal element for enabling movement of said piston, and an elongated housing having an anterior and posterior end and an interior wall able to house said piston, guide and thermal element. The housing further has two or more passages able to aid the piston in regulating flow, with at least one of the passages placed towards said anterior end of the housing, and at least one of the passages placed towards said posterior end of the housing.

Another example is disclosed in a U.S. Pat. No. 9,482,357 entitled “Temperature controlled purge valve for use in water systems” (the “357 Patent”). The '357 Patent discloses a thermally actuated valve having a housing, a resilient seat, a thermally conductive piston, a spring fluid seal, and a working material. The housing defines an inlet and an outlet and has two chambers. The seat is adjacent the inlet and the piston is adapted to move towards the seat when a working fluid in the housing warms and expands and away from the seat when a working fluid in the housing cools. By moving away from the seat, fluid flow through the valve is generated. In one application, Applicant's valve acts as a freeze prevention device. In another application, Applicant's valve is used to cool a source of water.

The above discussed valves are useful in regulating flow of water through them and thereby preventing the freezing of the pipes. However, they have several problems. For instance, each of the design discussed above consists of a singular hardware component (manual valve controlled by temperature and pressure of water to open and close valves), that functions only when the water temperature reaches a certain degree either up or down to interrupt the water pressure. The pressure caused by temperature is what opens and closes the valves. However, they do not drain the water effectively from the structure and prevent the pipes from getting damaged when needed.

Therefore, there is a need for improved system comprising electronic valves installed on waterlines, the electronic valves controlled remotely using an electronic device for opening and closing the electronic ball valves to cause the water to drain out and supply water back into the structure for protecting the waterlines from freezing and damage.

### BRIEF SUMMARY OF THE INVENTION

It is an object of the present subject matter to provide a system having electronic valves that help to prevent freezing of the pipes and avoids the drawback of known valves.

It is another object of the present subject matter to provide a system comprising electronic valves installed on waterlines, the electronic ball valves controlled remotely using an electronic device for opening and closing the electronic ball valves to cause the water to drain out and supply water back into the structure for protecting the waterlines from freezing and damage.

It is another object of the present subject matter to provide a system comprising electronic valves that help to drain the water effectively from the structure and prevent the waterlines from getting damaged when needed.

In order to overcome the limitations here stated, the present subject matter provides a system having electronic valves connected to waterlines i.e., main waterline and drain line. The electronic valves communicatively connect to an electronic device. In one example, each electronic valve includes an electronic ball valve. A user operates the electronic device to winterize and de-winterize the structure. Winterizing includes closing the electronic valve on the main waterline that supplies water into the structure and opening and closing the electronic valve on the drain line causing the water to drain out. De-wintering includes closing the electronic valve on the drain line and opening the electronic valve on the main waterline to supply water back into the structure. Winterizing prevents the waterlines from freezing and getting damaged in cold weather conditions.

The electronic valve encompasses a rotary ball with a bore or hole. The rotary ball rotates approximately 90 degrees around its axis within the electronic valve and controls the flow of water through the bore. The user controls the operation of the electronic valves remotely to winterize and de-winterize and prevents the waterline from freezing and getting damaged.

In one aspect of the present invention, the system includes a main line for supplying water. The system includes an electronic valve installed on the mainline. The electronic valve is a two or three-way valve. The system includes a return line connecting the electronic valve. The system includes a drain line connecting the electronic valve. The electronic valve is positioned to allow water to flow from the mainline and into a structure through the return line while closing the drain line. The electronic valve is positioned to allow the return line to back feed the water from the structure out of the drain line while closing the mainline.

The return line comprises an Air/Vacuum Valve (AVV). The AVV prevents vacuum from forming when the electronic valve is closed in order to allow the return line to back feed the water from the structure out of the drain line while closing the mainline. Further, the AVV purges air from the return line and the mainline when the electronic valve is positioned to allow the water to flow from the mainline and into the structure through the return line while closing the drain line.

Further, the system includes a temperature sensor, and a control center connecting the electronic valve. The control center positions the electronic valve to allow the return line to back feed the water from the structure out of the drain line while closing the mainline when the temperature goes below a predefined level. Furthermore, the control center positions the electronic valve to allow the water to flow from the mainline and into the structure through the return line while closing the drain line when the temperature reaches or goes above said predefined level.

In one advantageous feature of the present subject matter, the system gives the user the ability to winterize the structure without having to be physically present at the structure and de-winterize when it is occupied. This allows the user to save time and eliminates the need to physically operate the valves on existing waterlines in bad weather conditions.

In another advantageous feature of the present subject matter, the system monitors the temperature of the structure and/or pipes to “winterize” the pipe if it detects an unsafe temperature for an extended amount of time. Further, the system monitors flow within the pipes to help detect leaks which would then “winterize” the dwelling as well. In addition, the system has a capability to connect to user's electronic device. This allows the user to get notification and control the system remotely. Optionally, the system includes a control center/box for operating the electronic valve manually.

Features and advantages of the subject matter hereof will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

The present subject matter will now be described in detail with reference to the drawings, which are provided as illustrative examples of the subject matter as to enable those skilled in the art to practice the subject matter. It will be noted that throughout the appended drawings, like features are identified by like reference numerals. Notably, the FIGUREs and examples are not meant to limit the scope of the present subject matter to a single embodiment, but other embodiments are possible by way of interchange of some or all of the described or illustrated elements and, further, wherein:

FIG. 1 illustrates a network communications system that facilitates to winterize and de-winterize a structure, in accordance with one embodiment of the present subject matter;

FIG. 2 illustrates a perspective view of an electronic valve;

FIG. 3 illustrates a cross-sectional view of a valve body;

FIG. 4 shows a block diagram of a housing;

FIG. 5 illustrates electronic valves connecting the waterline;

FIG. 6 illustrates an exemplary scenario of providing instructions from an electronic device to control operation of electronic valves;

FIG. 7 illustrates a method of winterizing and de-winterizing a structure for preventing waterlines from freezing, in accordance with one embodiment of the present subject matter;

FIG. 8 illustrates a network communications system that facilitates to winterize and de-winterize a structure, in accordance with another embodiment of the present subject matter;

FIGS. 9 and 10 illustrate the operation of an electronic valve, in accordance with one embodiment of the present subject matter; and

FIGS. 11, 12 and 13 illustrate the flow paths of the electronic valve, in accordance with one embodiment of the present subject matter.

### DETAILED DESCRIPTION OF THE EMBODIMENTS

The detailed description set forth below in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed system. However, it will be apparent to those skilled in the art that the presently disclosed subject matter may be practiced without these specific details. In some instances, well-known structures and devices are shown in functional or conceptual diagram form in order to avoid obscuring the concepts of the presently disclosed system.

In the present specification, an embodiment showing a singular component should not be considered limiting. Rather, the subject matter preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present subject matter encompasses present and future known equivalents to the known components referred to herein by way of illustration.

Although the present subject matter describes a system, it is to be further understood that numerous changes may arise in the details of the embodiments of the system. It is contemplated that all such changes and additional embodiments are within the spirit and true scope of this subject matter.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the subject matter and are not intended to limit the scope of the subject matter.

It should be understood that the present subject matter describes a system and method of winterizing and de-winterizing a structure in order to prevent waterlines from freezing and getting damaged. The system includes electronic valves connected to waterlines i.e., main waterline and drain line. The electronic valves include electronic ball valves. The electronic valves communicatively connect to an electronic device. A user operates the electronic device to winterize and de-winterize the structure. Winterizing includes closing the electronic ball valve on the main waterline that supplies water into the structure and opening and closing the electronic ball valve on the drain line causing the water to drain out. De-wintering includes closing the electronic ball valve on the drain line and opening the electronic ball valve on the main waterline to supply water back into the structure. Winterizing prevents the waterlines from freezing and getting damaged in cold weather conditions.

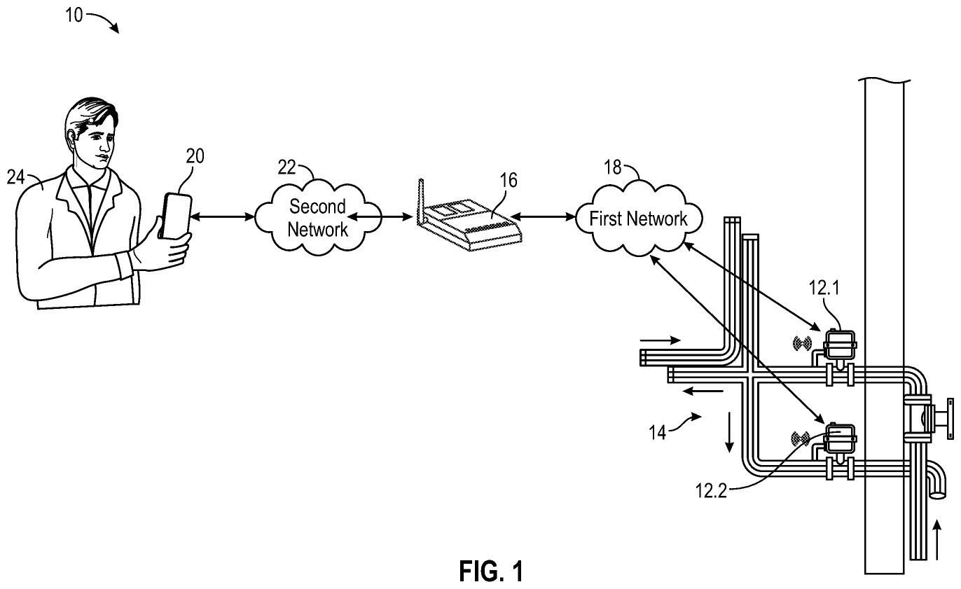

Various features and embodiments of a system for winterizing and de-winterizing a structure to prevent waterlines from freezing and getting damaged are explained in conjunction with the description of FIGS. 1 to 13.

In one embodiment, the present subject matter discloses a system for winterizing and de-winterizing a structure. FIG. 1 shows a high-level block diagram of an exemplary network communications system 10 that facilitates in winterizing and de-winterizing a structure, in accordance with one embodiment of the present subject matter. For ease of reference, network communications system 10 is referred to as system 10 throughout the description. System 10 includes one or more electronic valves such as first electronic valve 12.1, second electronic valve 12.2, collectively referred as electronic valves 12 or simply electronic valve 12. In a preferred embodiment, electronic valve 12 includes electronic ball valve. Alternatively, electronic valve 12 may include any other electronic valve known in the art.

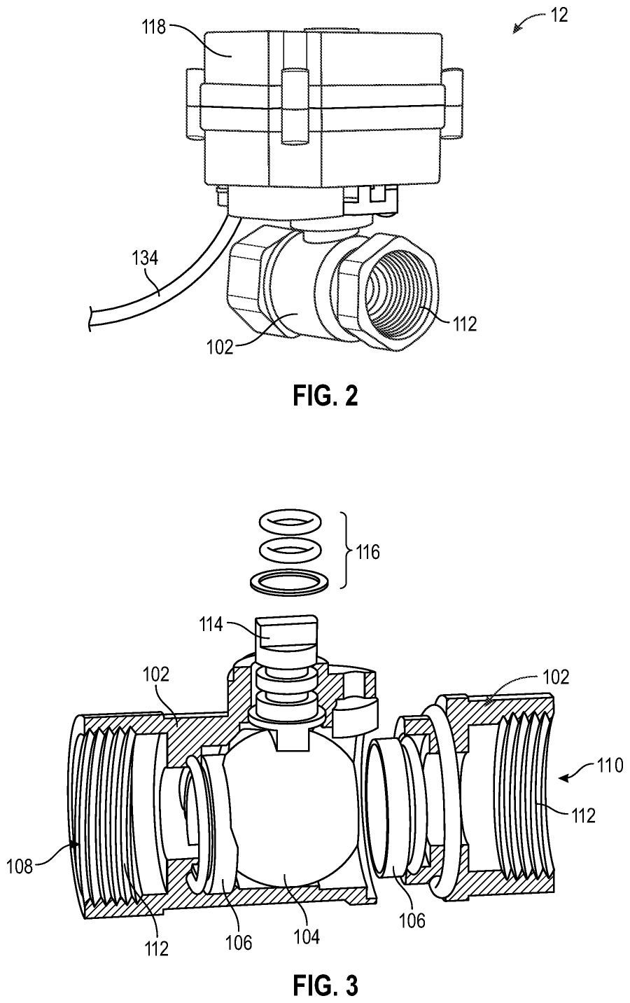

FIG. 2 shows a perspective view of electronic valve 12, in accordance with one embodiment of the present subject matter. Electronic valve 12 includes valve body 102. Valve body 102 provides a material made of metal, hard plastic or any other material. Valve body 102 provides a rigid material capable of withstanding internal pressure of water flowing through it and external pressure and impact exerted at the outer side. Valve body 102 provides a hollow structure such a tube or pipe having size same as waterline 14. FIG. 3 shows a cross-sectional view of valve body 102. Valve body 102 encompasses rotary ball 104. Rotary ball 104 provides a material made of metal such as brass or stainless steel, Polyvinyl chloride (PVC), or any other material. Rotary ball 104 presents a bore or hole (not shown) at the centre. The bore may come in a variety of shapes including, but not limited to, reduced bore, full bore, V-shaped bore, etc. The shape of bore is selected based on the desired flow rate of the water in waterline 14 and/or valve body 102. Rotary ball 104 rotates approximately 90 degrees around its axis within valve body 102 and controls the flow of water through the bore. Rotary ball 104 encompasses in seat rings 106. In other words, seat rings 106 surround rotary ball 104 and ensures rotary ball 104 stays in place. Further, valve body 102 includes inlet port 108 and outlet port 110. Water enters through inlet port 108, flows through the bore of rotary ball 104 (in open configuration) and exits through outlet port 110. Inlet port 108 and outlet port 110 include threaded portion 112 for connecting electronic valve 12 to waterline 14 (main waterline 204 or drain line 212). Electronic valve 12 presents stem 114 that extends from rotary ball 104 at the top. Stem 114 includes sealing O-rings 116 that mount around stem 114. Sealing O-rings 116 allow to properly seal stem 114 and prevent leakage of water at stem 114. Here, stem 114 connects to rotary ball 104, which is supported and sealed by seat rings 106.

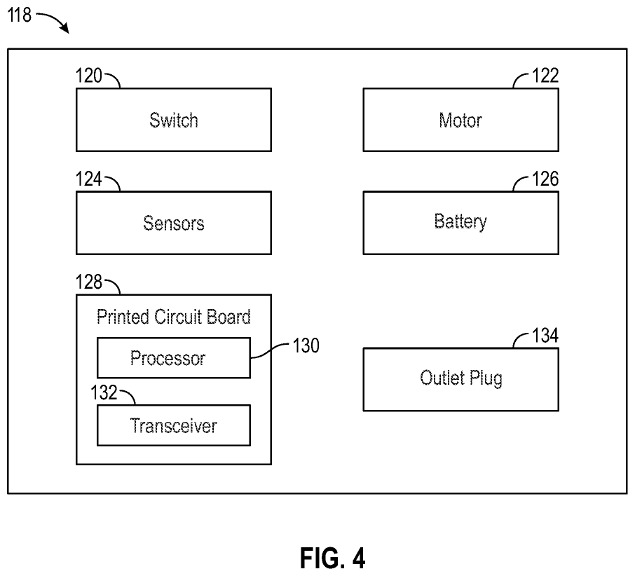

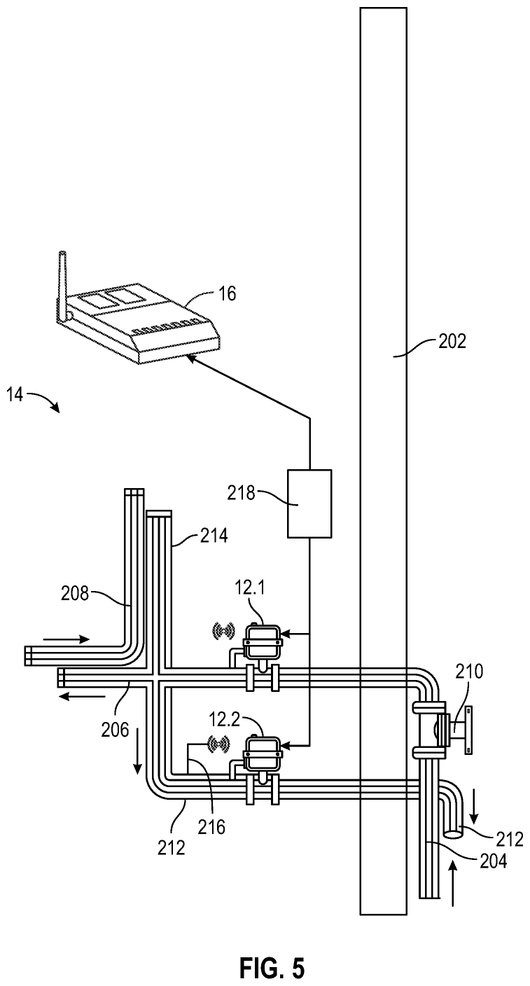

Stem 114 connects to motor 122 provided in housing 118. FIG. 4 shows a block diagram of housing 118 encompassing electronic components for controlling operation of rotary ball 104 via stem 114 to allow or stop flowing of water through it. Housing 118 comes in a variety of shapes, including, but not limited to, square, rectangular, oval, or any other shape. Housing 118 mounts over stem 114, as shown in FIG. 2. Housing 118 encompasses switch 120 at the outer surface (FIG. 5). Switch 120 allows user 24 to manually control or override the operation of rotary ball 104 to allow or stop flowing of water through it. Housing 118 includes motor 122 operationally connecting stem 114. Motor 118 operates and controls the rotation or turn of stem 114 in order to control the flow of water through the bore of rotary ball 104. In one example, housing 118 presents one or more sensors 124. Sensors 124 include one of temperature sensors, pressure sensors, water level sensors, etc. Temperature sensors detect temperature of water flowing through valve body 102. Pressure sensors detect water pressure. Water level sensors detect level or height of water flowing through valve body 102. In addition, housing 118 encompasses battery 126 for powering motor 122 and other electronic components. Further, housing 118 encompasses printed circuit board (PCB) 128. PCB 128 includes processor 130 and transceiver 132. Processor 130 includes a microprocessor that stores and processes information or data to operate electronic valve 12. In one example, processor 130 puts electronic valve 12 in SLEEP mode and turns OFF motor 122 when not in use. This helps to put electronic valve 12 in standby or SLEEP mode and prolongs life of battery 126. Transceiver 132 configures to communicate with external devices such as router 16 and/or electronic device 22 (FIG. 1). In addition, housing 118 includes outlet plug 134 that connects to existing wiring or power source at home/business to power electronic valve 12.

As shown in FIG. 1, electronic valves 12 i.e., first electronic valve 12.1, second electronic valve 12.2 connect to waterline 14 in a structure such as a home or business/office. FIG. 5 shows first electronic valve 12.1, second electronic valve 12.2 connecting waterline 14, in accordance with one embodiment of the present subject matter. Waterline 14 indicates a pipeline supplying water into the structure and draining water away from the structure. Here, the structure may include home or office or any temporary or permanent structure/building. Waterline 14 provides a material made of synthetic plastic polymer such as Polyvinyl chloride (PVC) or copper or any other known material. Waterline 14 connects to wall 202 e.g., exterior wall of the structure. Waterline 14 includes main waterline 204. Main waterline 204 refers to a pipe that draws water from a water supply source or pump and supplies to the structure. In one example, main waterline 204 supplies water to first water pipe 206 and second water pipe 208. In one example, first water pipe 206 refers a pipe that supplies water to a room, say kitchen or bathroom for utility purpose. Second water pipe 208 refers to a pipe that supplies water to an appliance e.g., water heater. A person skilled in the art understands that main waterline 204 may connect to any number of pipes in the structure to supply water depending on the need. Main waterline 204 includes shutoff valve 210 that allows or cuts off supply of water to the structure. A person skilled in the art understands that opening shutoff valve 210 supplies water to the structure from the water supply source and closing shutoff valve 210 stops the supply of water to the structure. Further, waterline 14 includes drain line 212. Drain line 212 indicates a pipe that carries water away from the structure. In the present embodiment, drain line 212 drains out water from waterline 14 to drainage at the outside side of the structure, as shown in FIG. 5. Further, drain line 212 includes vent tube 214 that runs from second electronic valve 12.2 insert off to the upmost level of plumbing in the home. Vent tube 214 includes check or pop it valve 216 to syphon air during the drain process and bleed the air from pipes during supply. Pop it valve 216 is a manual valve that is controlled by the water pressure actuating the valve.

In accordance with one embodiment of the present subject matter, first electronic valve 12.1 connects at main waterline 204 and second electronic valve 12.2 connects at drain line 212 (FIG. 5). In order to connect first electronic valve 12.1 at main waterline 204, user 24 locates shutoff valve 210 and turns off. Subsequently, user 24 connects first electronic valve 12.1 to main waterline 204 at appropriate location, in that water enters into first electronic valve 12.1 through inlet port 108 and exits through outer port 110 before flowing through first water pipe 206 and second water pipe 208. Similarly, user 24 connects second electronic valve 12.2 to drain line 212 at appropriate location, in that water enters into second electronic valve 12.2 through inlet port 108 and exits through outlet port 110 before flowing out of the structure into a drainage. In one implementation, user 24 cuts a portion of main waterline 204 and drain line 212 to connect first electronic valve 12.1 and second electronic valve 12.2, respectively. Alternatively, first electronic valve 12.1 and second electronic valve 12.2 come pre-installed on main waterline 204 and drain line 212, respectively from their manufacturing facility itself.

In accordance with the present subject matter, each of first electronic valve 12.1 and second electronic valve 12.2 communicatively connects to router 16 via first network 18. In one example, router 16 indicates a device that communicates with first electronic valve 12.1 and second electronic valve 12.2 using a short-range communication protocol. Router 16 utilizes short-range communication protocols such as Bluetooth, NFC, intranet, local area network (LAN), or any other communication protocol to communicate with first electronic valve 12.1 and second electronic valve 12.2. In one example, router 16 includes a Wi-Fi router utilizing Wi-Fi protocol to communicate with first electronic valve 12.1 and second electronic valve 12.2. Router 16 installs at the structure and allows first electronic valve 12.1 and second electronic valve 12.2 to communicate with electronic device 20 over internet/intranet via second network 22. In one example, first electronic valve 12.1, second electronic valve 12.2 and router 16 connect to backup battery 218. Backup battery 218 supplies power to first electronic valve 12.1, second electronic valve 12.2 and router 16 in the event of power failure. This way system 10 operates in all-weather conditions.

Electronic device 20 includes, but not limited to, a desktop computer, a tablet, a mobile phone, a smart watch, etc. Here, second network 22 indicates a long-range communication protocol such as cellular, satellite, local area network (LAN), wide area network (WAN), the internet and the like.

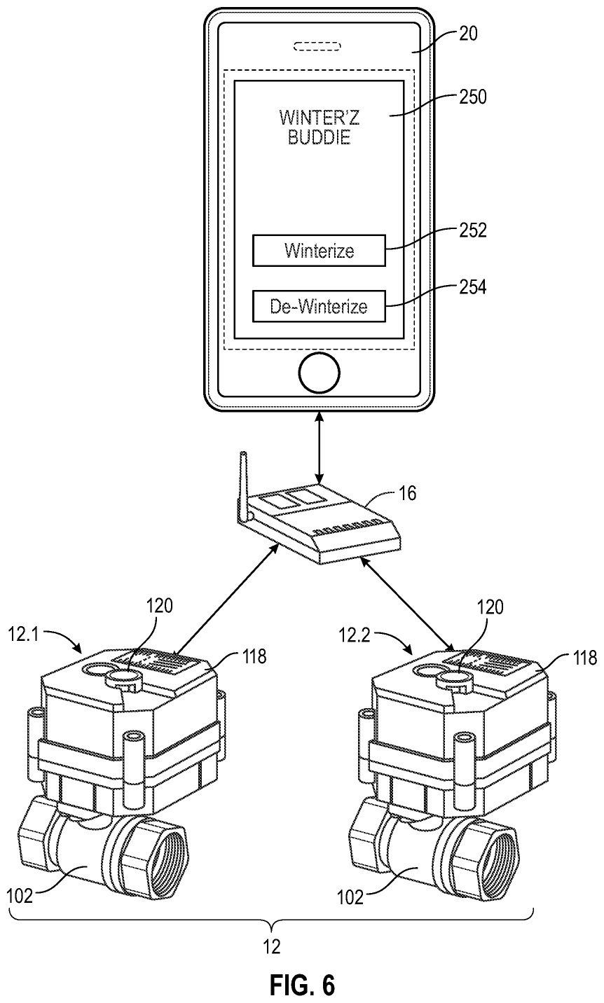

In the present embodiment, user 24 operates electronic device 20 to control the operation of first electronic valve 12.1 and second electronic valve 12.2 via router 16. Specifically, user 24 uses electronic device 20 to control the operation of first electronic valve 12.1 and second electronic valve 12.2 in order to drain out water or supply water to waterline 14 for preventing the water to freeze and damage waterline 14. In order to operate first electronic valve 12.1 and second electronic valve 12.2, electronic device 20 presents an application or user interface 250. FIG. 6 shows an exemplary interface in which user 24 provides instructions using electronic device 20 to control operation of first electronic valve 12.1 and second electronic valve 12.2. In one example, application 250 presents options such as “winterize” 252 and “de-winterize” 254. Here, the term “winterize” indicates draining water from waterline 14 thereby allowing waterline 14 to withstand cold temperatures and freezing pipes. “De-winterize” indicates supplying water back into waterline 14.

User 24 presses one of winterize 252 and de-winterize 254 on application 250 to control first electronic valve 12.1 and second electronic valve 12.2. Pressing winterize 252 and de-winterize 254 transmits a signal or instruction to transceiver 132 in first electronic valve 12.1 and second electronic valve 12.2, respectively. Transceiver 132 then sends the instructions to processor 130 to engage motor 122 to control the operation of rotary ball 104 in first electronic valve 12.1 and second electronic valve 12.2.

For instance, when user 24 wishes to winterize the structure to prevent waterline 14 from freezing, user 24 presses winterize 252 on electronic device 20. Pressing winterize 252 transmits a signal to first electronic valve 12.1 causing it to close rotary ball 104 to cut off water flowing through it. This stops the water flowing into the structure through main waterline 204. Concurrently or consecutively, pressing winterize 252 transmits a signal to second electronic valve 12.2 causing it to open rotary ball 104 to allow water to flow out via drain line 212. This causes the water to drain out in waterline 14. By draining out the water in waterline 14, system 10 ensures that waterline 14 does not burst due to water freezing in it in cold weather conditions i.e., when ambient temperatures drop to 32° Fahrenheit (F) or 0° Celsius (C) and below.

Further, when user 24 wishes to de-winterize, user 24 presses de-winterize 252 on electronic device 20. Pressing de-winterize 252 transmits a signal to second electronic valve 12.2 causing it to close rotary ball 104 on drain line 212. Concurrently or consecutively, pressing de-winterize 252 transmits a signal to first electronic valve 12.1 causing it to open rotary ball 104 to supply water to main waterline 204 and then into first water pipe 206 and second water pipe 208.

The above description explains manually controlling the operation of first electronic valve 12.1 and second electronic valve 12.2 to protect waterline from freezing and water damage. In one alternate embodiment, sensors 124 in each of first electronic valve 12.1 and second electronic valve 12.2 detect temperature of water, water level and/or water pressure and automatically control the operation of electronic valve 12.1 and second electronic valve 12.2 to drain out water in waterline 14 and/or supply water to waterline 14 as explained above. In one implementation, sensors 124 detect the ambient temperature is dropping to 0° C. and/or below and transmit a signal to electronic device 20 via transceiver 132. User 24 receives a notification on his electronic device 20 and presses winterize 252 to drain out water from waterline 14 and prevents it from freezing. When sensors 124 detect the ambient temperature has reached safe temperature say 5° C., then transceiver 132 transmits a signal to electronic device 20. At that time, user 24 presses de-winterize 254 to supply back the water into waterline 14 as explained above.

In the present subject matter, user 24 controls operation of electronic valve 12.1 and second electronic valve 12.2 remotely using electronic device 20 to winterize and de-winterize the structure. This eliminates the need for user 24 to be present at the structure in cold weather conditions and allows him to save time. As such, system 10 provides utility in structures that are occupied full time such as homes or offices. Further, system 10 provides utility in structures that are not occupied full time such as vacation homes, rentals, shops, and the like.

Although the above description is explained considering that electronic valve 12 includes two ports i.e., inlet port 108 and outlet port 110, a person skilled in the art understands electronic valve 12 may come with two, three or even four ports allowing them to be used with a variety of waterlines 14 to winterize and de-winterize the structure without departing from the scope of the present subject matter.

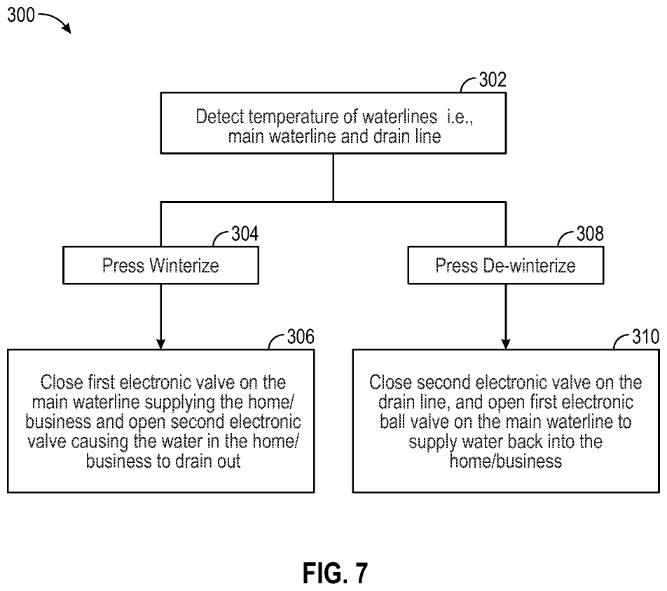

FIG. 7 shows a method 300 of winterizing and de-winterizing a structure for preventing waterlines from freezing, in accordance with one exemplary embodiment of the present disclosure. The order in which method 300 is described should not be construed as a limitation, and any number of the described method blocks can be combined in any order to implement method 300 or alternate methods. Additionally, individual blocks may be deleted from method 300 without departing from the spirit and scope of the disclosure described herein. However, for ease of explanation, in the embodiments described below, method 300 may be implemented using the above-described system 10.

At step 302, user 20 detects the temperature of water in waterline 14 i.e., main waterline 204 and drain line 212 either manually or using sensors 124. User 24 detects the temperature either manually or with the help of sensors 124. Upon detecting the temperature, user 24 presses winterize 252 on electronic device 20 (step 304). Pressing winterize 252 on electronic device 20 closes first electronic valve 12.1 on main waterline 204 supplying water to the home/business and opens second electronic valve 12.2 (step 306). This drains out the water through drain line 212 and prevents waterline 14 from freezing due to water collected in it.

At step 308, user 24 presses de-winterize 254 on electronic device 20. Pressing de-winterize 254 on electronic device 20 closes second electronic valve 12.2 on drain line 212 and opens first electronic valve 12.1 on main waterline 204 to supply water back into the home/business.

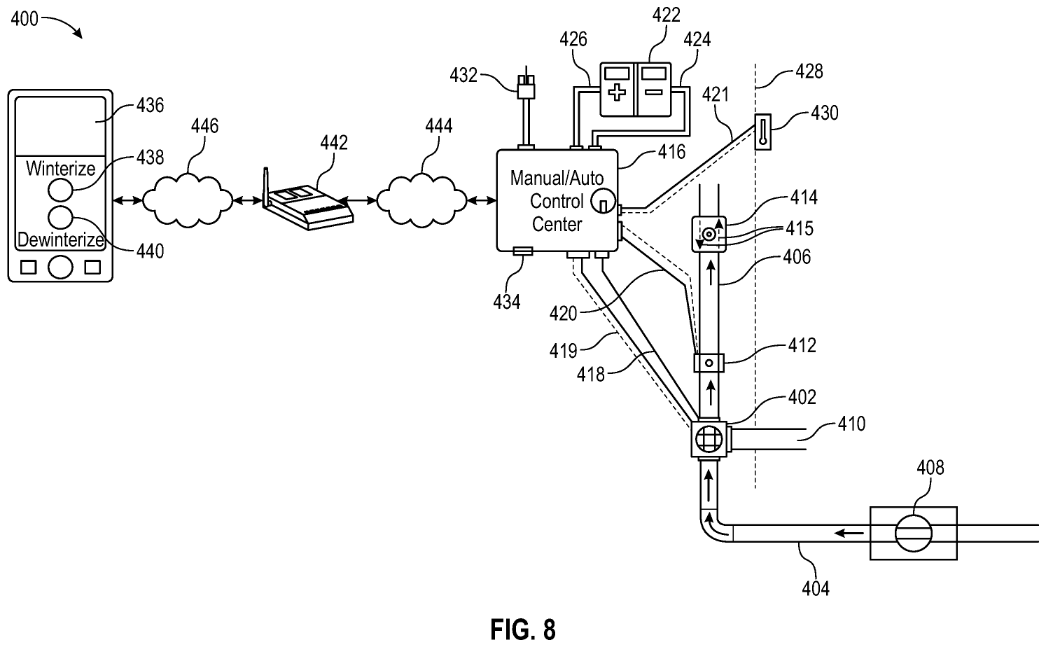

Now referring to FIG. 8, an exemplary network communications system 400 that facilitates in winterizing and de-winterizing a structure, in accordance with one embodiment of the present subject matter. For ease of reference, network communications system 400 is referred to as system 400 throughout the description. System 400 includes an electronic valve 402 installed on a mainline 404. Electronic valve 402 includes a 3 way, ¾″ full port, electronic ball valve. Mainline 404 connects to supply/return line 406. Optionally, electronic valve 402 includes a 2 way valve. As can be seen, supply/return line 406 extends from mainline 404 via electronic valve 12. In one example, mainline 404 includes a main water valve 408. Water valve 408 helps to control the supply of water into mainline 404. Further, mainline 404 connects to a drain line 410. Drain line 410 helps to drain the water.

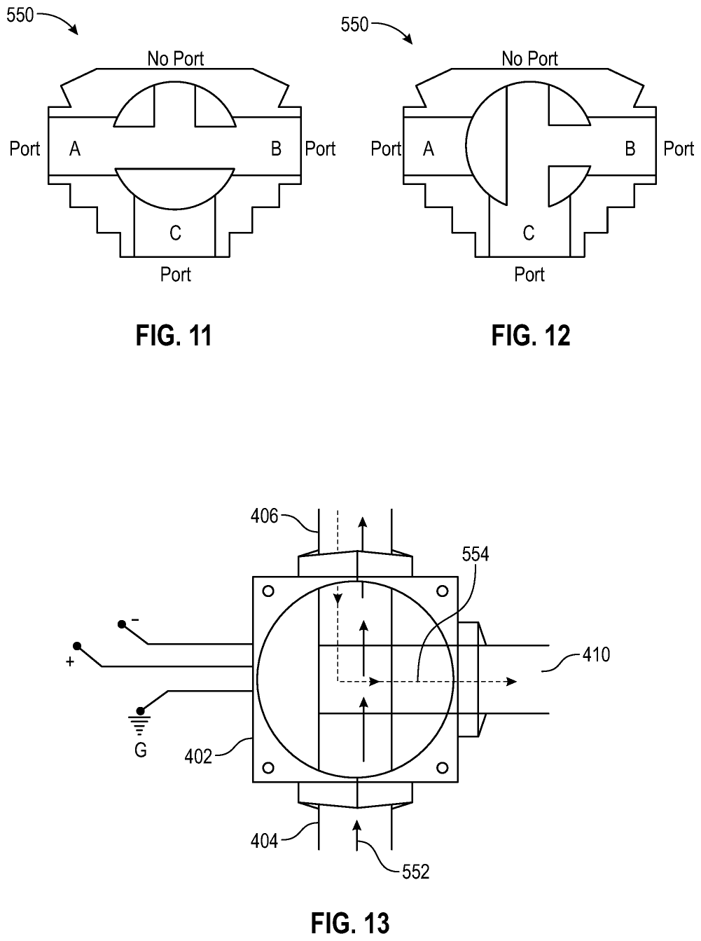

FIGS. 11 and 12 show T-flow paths 550 of electronic valve 412 disclosed above. As can be seen, electronic valve 12 has 3 way, T-port, full port ball valve, with four seats. The four seats allow to use any port as an entry port and offers an optional straight through flow and shut-off capabilities. Here, A refers to mainline, B refers to supply/return line and C refers to drain line. FIG. 13 shows a flow of water 552 in a closed and actuated position, and a flow of water 554 in an open position.

Referring back to FIG. 8, supply/return line 406 includes a flow meter 412. Flow meter 412 indicates a water flow meter or a sensor configured for monitoring the amount of the water flowing through supply/return line 406. Further, supply/return line 406 includes an Air/Vacuum Valve (AVV) 414 at its distal end. Electronic valve 402 and flow meter 412 connect to a control center 416. In one example, electronic valve 12 connects to control center 416 via wires 418, 419. Flow meter 412 connects to control center 416 via wire 420.

Control center 416 is installed inside of a structure 430. Control center 416 connects to a battery 422 via a wire 424, 426. Here, control center 416 is powered by battery 422. Optionally, control center 416 connects to a power source 432 e.g., 100 Vac plug. In the absence of power from power source 432, control center 416 operates using the power drawn from battery 422. Further, system 400 includes a temperature sensor 428 installed at the outside of structure 430. Temperature sensor 428 monitors temperature and notifies control center via wire 421 when the temperature drops to 29 or 36 degrees Fahrenheit or lower (predefined level). Further, control center 416 includes a transceiver 434 for transmitting and receiving data from an electronic device 436.

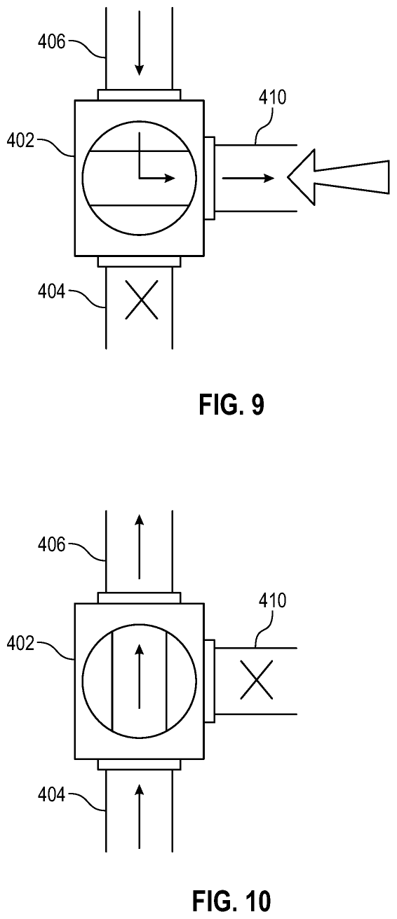

Now referring to FIGS. 9 and 10, operation of the electronic valve 402 is explained. As can be seen in FIG. 10, electronic valve 402 is installed on mainline 404. Mainline 404 supplies the water to structure 430 when electronic valve 402 is open. This position is considered as “De-winterize” i.e., operating using second button 440. Referring to FIG. 9, electronic valve 402 used to stop water supply from mainline 404 is shown. Here, electronic valve 402 is switched to allow supply/return line 406 to backfeed water from structure 230 out of drain line 410. This position is considered as “Winterize” i.e., operating using first button 438.

It should be understood that in case of a power outage, control center 426 sets the operation mode to “Winterize” position, as shown in FIG. 9, in order to drain and protect structure 430. Further, when “Winterize” is selected using first button 438, electronic valve 402 closes mainline 404 shutting off the water coming into structure 430 and opening drain line 410 to evacuate all water in all pipes/lines in structure 430. During the “Winterize” operation, AVV 414 prevents vacuum from forming. This helps in the complete draining of pipes. Further, when “De-winterize” (second button 440) is selected, electronic valve 402 closes drain line 410 and opens mainline 404 allowing the water to flow into structure 430 through supply/return line 406 as normal. During “De-Winterize” operation, AVV 414 purges air from the pipes as mainline 404 continues to pressurize the structure's entire water supply. A person skilled in the art understands that AVV 414 is installed after electronic valve 402 on supply/return line 406 in order to purge system 400 of air during both “Winterize” and “De-winterize” processes. This helps the entire structure to have empty pipes ensuring none of the pipes freeze.

In the present embodiment, control center 416 allows a user (not shown) to operate electronic valve 402 using electronic device 436. Here, electronic device 436 includes a first button 438 and a second button 440. Upon pressing first button 438, “Winterize” operation is performed by electronic valve 402. Upon pressing second button 440, “De-winterize” operation is performed by electronic valve 402. Electronic device 436 communicatively connects to control center 416 via a router 442. In one example, control center 416 communicatively connects to router 442 using a first network 444. In one example, router 442 communicatively connects to electronic device 436 using a second network 450. Each of first network 444 and second network 446 indicates a short or long-range communication protocol including, but not limited to, Bluetooth, Wi-Fi, cellular, satellite, local area network (LAN), wide area network (WAN), the internet and the like. The presently disclosed electronic valve 402 can be operated from remotely using the network system explained above. In one example, electronic device 436 is preprogramed to operate electronic valve 402 when certain conditions are met.

In one example (first condition), temperature is measured by temperature sensor 428 (to accurately monitor for temperature drop of 28 degrees F. or lower. In other condition (second condition), consider the first condition is in effect, the flow meter 412 is made to measure the flow rate of water. If the first condition is in place and the flow is irregular or stopped, then system 400 moves to a third condition. In the third condition, once both first condition and the second condition are in effect, a timer begins counting down from a default set time (say 30 minutes) and system 400 alerts the user of the action(s) via electronic device 436. If all conditions are met and the timer reaches 0 minutes with no interruption from user, then system 400 switches to “Winterize”. Furthermore, once the temperature sensor 428 reads 36 degree F. or higher, system 400 alerts the user via electronic device 436 that its reached a safe temperature and to “De-Winterize” structure 430.

Based on the above, it is evident that the above disclosed system allows the user to winterize and de-winterize the structure such as home or business using the electronic device. By winterizing the structure, the user need have to worry about cold nights and winter days that are subject to freeze pipelines or waterlines throughout the structure, resulting in catastrophic damage that are expensive to replace.

A person skilled in the art appreciates that the device may come in a variety of sizes depending on the need and comfort of the first responders. Further, different materials in addition to or instead of materials described herein may also be used and such implementations may be construed to be within the scope of the present subject matter. Further, many changes in the design and placement of components may take place without deviating from the scope of the presently disclosed system.

In the above description, numerous specific details are set forth such as examples of some embodiments, specific components, devices, methods, in order to provide a thorough understanding of embodiments of the present subject matter. It will be apparent to a person of ordinary skill in the art that these specific details need not be employed, and should not be construed to limit the scope of the subject matter.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the subject matter, it is intended that all matter contained in the above description or shown in the accompanying drawings shall be interpreted as illustrative and not in a limiting sense.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. It is contemplated that additional embodiments are within the spirit and true scope of the disclosed subject matter.

What is claimed is:

1. A system of winterizing and de-winterizing a structure, comprising:
a main line for supplying water;
an electronic valve installed on said mainline, wherein said electronic valve is a three way valve;
a return line connecting said electronic valve; and
a drain line connecting said electronic valve,
wherein said electronic valve is positioned to allow water to flow from said mainline and into said structure through said return line while closing said drain line, and
wherein said electronic valve is positioned to allow said return line to back feed the water from said structure out of said drain line while closing said mainline.

2. The system of claim 1, wherein said return line comprises an Air/Vacuum Valve (AVV).

3. The system of claim 2, wherein said AVV prevents vacuum from forming when said electronic valve is closed in order to allow said return line to back feed the water from said structure out of said drain line while closing said mainline.

4. The system of claim 2, wherein said AVV purges air from said return line and said mainline when said electronic valve is positioned to allow the water to flow from said mainline and into said structure through said return line while closing said drain line.

5. The system of claim 1, wherein said return line comprises a flow meter, and wherein said flow meter measures the amount of water flowing through said return line.

6. The system of claim 5, wherein said electronic valve and said flow meter connect to a control center, and wherein said control center switches the position of said electronic valve.

7. The system of claim 6, further comprises an electronic device, wherein said electronic device communicatively connects to said control center, and wherein said electronic device remotely operates said electronic valve.

8. The system of claim 1, further comprises a temperature sensor, wherein said temperature sensor monitors temperature of the water in said return line.

9. The system of claim 8, wherein said electronic valve connects to a control center, wherein said temperature sensor connects to said control center, and wherein said control center positions said electronic valve to allow said return line to back feed the water from said structure out of said drain line while closing said mainline when the temperature goes below a predefined level.

10. The system of claim 9, wherein said control center positions said electronic valve to allow the water to flow from said mainline and into said structure through said return line while closing said drain line when the temperature reaches or goes above said predefined level.

11. The system of claim 10, wherein said control center positions said electronic valve to allow the water to flow from said mainline and into said structure through said return line while closing said drain line when the temperature reaches or goes above said predefined level at a predefined time interval.

12. A method of winterizing and de-winterizing a structure, said method comprising the steps of:
providing a main line for supplying water;
providing an electronic valve installed on said mainline, said electronic valve being a three way valve;
providing a return line connecting said electronic valve;
providing a drain line connecting said electronic valve;
positioning said electronic valve to allow water to flow from said mainline and into said structure through said return line while closing said drain line; and
positioning said electronic valve to allow said return line to back feed the water from said structure out of said drain line while closing said mainline.

13. The method of claim 12, further comprising providing an Air/Vacuum Valve (AVV) at said return line.

14. The method of claim 13, preventing vacuum from forming by said AVV when said electronic valve is closed for allowing said return line to back feed the water from said structure out of said drain line while closing said mainline.

15. The method of claim 13, purging air from said return line and said mainline by said AVV when said electronic valve is positioned to allow the water to flow from said mainline and into said structure through said return line while closing said drain line.

16. The method of claim 12, further comprising providing a flow meter at said return line, said flow meter configured for measuring the amount of water flowing through said return line.

17. The method of claim 16, further comprising providing a control center connecting said electronic valve and said flow, said control center configured for switching the position of said electronic valve.

18. The method of claim 1, further comprising a temperature sensor, said temperature sensor monitoring temperature of the water in said return line.

19. The method of claim 18, further comprising connecting said electronic valve to a control center, said temperature sensor connecting to said temperature sensor, said control center positioning said electronic valve to allow said return line to back feed the water from said structure out of said drain line while closing said mainline when the temperature goes below a predefined level.

20. The method of claim 19, further comprising positioning said electronic valve to allow the water to flow from said mainline and into said structure through said return line while closing said drain line when the temperature reaches or goes above said predefined level.
